(19) United States
(12) Patent Application Publication
(10) Pub. No.: US 2014/0114894 A1
(43) Pub. Date: Apr. 24, 2014

(54) Method for Finding Shortest Pathway between Neurons in A Neural Network

(71) Applicants: National Applied Research Laboratory, Taipei (TW); National Tsing Hua University, Hsin Chu (TW)

(72) Inventors: Ann-Shyn Chiang, Hsin Chu (TW); Ching-Yao Lin, Hsin Chu (TW); Hsiu-Ming Chang, Hsin Chu (TW); Kuen-Long Tsai, Hsin Chu (TW); Chang-Huain Hsieh, Hsin Chu (TW)

(73) Assignees: National Applied Research Laboratory, Taipei (TW); National Tsing Hua University, Hsin Chu (TW)

(21) Appl. No.: 13/895,999

(22) Filed: May 16, 2013

(30) Foreign Application Priority Data
Oct. 19, 2012 (TW) 101138827

(51) Int. Cl. G06N 3/04

(52) U.S. Cl. CPC G06N 3/04
USPC 706/26

(57) ABSTRACT

The present invention discloses a method for finding shortest pathways between neurons in a neural network, including: establishing a three dimensional or higher dimensional neural space database (which may be neuron image database) by a processing device in a storage space, wherein the three dimensional or higher dimensional neural space database includes a plurality of neurons distributed therein. Then, it is determined whether there is a connection between each of the plurality of neurons in the three dimensional or higher dimensional neural space database and the others of the plurality of neurons in the three dimensional or higher dimensional neural space database by the processing device, and subsequently a shortest pathway table of all of a plurality of connected neurons is calculated via an All-pairs Shortest Paths algorithm and is stored in the storage space.

### FIELD OF THE INVENTION

The present invention relates to a method for establishing the connecting pathways between neurons within a neural network, and more particularly to a method for finding shortest pathways between neurons through 3D neuron image data.

### BACKGROUND OF THE INVENTION

Researches on brain function may be divided into several levels, from microscopic to macroscopic, such as gene expression, protein biochemistry, cellular morphology, brain neural network organizations and animal behavior. Molecular biology, flourished since the 1960s, allows gene manipulation to result in consequences at different scales. In other words, according to basic research in life science, researchers can now make use of technologies to identify genes involved in Drosophila memory and alter them to influence behaviors. Although scientists have a clear understanding of macro-scale biology such as animal behavior and micro-scale biology such as gene expression and perspectives of biology, meso-scale biological research remains under-studied owing to technical limitations including the difficulty to acquire the 3D structure of nerve cells and neural network's formation. Now, the integration of biofluorescent labeling and optical section scanning in confocal microscopy gives rise to the possibility of high-resolution digital images of the brain and its neural network.

Biologists often can not obtain images (information) of an organism's internal structure without damaging the organism itself. Furthermore, when acquiring biological images, physical limitations of laboratory equipment could only generate a serial of two-dimensional (2D) images instead of three dimensional images; as a result, the spatial information between organs is not immediately made available. While an invention in 2002, U.S. Pat. No. 6,472,216 presents a sample preparation solution which enables scientists to acquire images from a transparent whole mount samples.

Owing to the technological advances in the twentieth century, it is generally accepted that a completely modular brain model can depict its functional validity. Therefore, the interpretation of brain function can be analytically and anatomically described based on the interactions among different brain regions or even neurons. Accordingly, 3D image reconstruction technology can be applied to build models of major compartments of the brain, and at the same time, merge the anatomy of neuropils or neurons with the function of neural networks in the brain.

Although the information processing and transmission mechanism of the human brain fascinates scientists and are main research topics, owing to the fact that the human brain has 100 billion neurons, plus human's relatively long life span and the legal and moral restriction, human genes cannot be manipulated at will. Neuroscientists thus turn their investigation to other organisms, e.g. mice, zebrafish and Drosophila. For instance, the Drosophila brain only has about 135,000 neurons, but can still exhibit complex memory and learning behaviors; consequently, it has become one of the most popular and important research targets in neuroscience. In addition Drosophila genes have been entirely sequenced, and its short life cycle (approximately 60 days) further makes it a feasible research target. Transparent brain tissues of Drosophila may be prepared by utilizing tissue clearing solution invented by one of the inventors of the present application (U.S. Pat. No. 6,472,216 B1 and TW patent No. 594005), and a system is established to collect single neuron image in Drosophila brain (TW patent No. 1291630 and U.S. Pat. No. 7,742,878B2). Nowadays, there are nearly twenty thousand brain neurons collected in the Drosophila brain, which are arranged appropriately according to their related physiological locations and therefore can be utilized as the basis for the research of the structure and function of the brain (Current Biology 2011, vol: 21: p 1-11 Three-dimensional reconstruction of brain-wide wiring networks in Drosophila at single-cell resolution; Pacific Visualization Symposium (PacificVis), 2011 IEEE, 1-4 Mar. 35-42 The Neuron Navigator: Exploring the information pathway through the neural maze).

For brain function research, the message transmission pathways may facilitate to solve the puzzle of how the brain works. Once the shortest pathway between two neurons can be found, it may provide clues to facilitate simulation of the transmission and interpretation of neural signals.

The existing techniques can obtain high resolution images of neurons and acquire three dimensional stereoscopic models by utilizing three dimensional stereoscopic image reconstruction techniques. However, for the shortest pathway between two neurons, there is no method in the past to present the shortest pathway between neurons; especially each neuron possesses irregular shape and complicated terminal branches. Therefore, there is a demand for a new method which can solve the problems and visualize results, otherwise further study on the transmission pathways in the neural network is impossible.

### SUMMARY OF THE INVENTION

One object of the present invention is to solve the problem of how to find the shortest pathway between every two neurons from the neuron images in three dimensional or higher dimensional neural networks.

To achieve the aforementioned object, the present invention provides a method for finding shortest pathways between neurons, with irregular shapes and complicated terminal branches, in a neural network. The method includes the following steps: establishing a neuron image database from three dimensional or higher dimensional neuron images by a processing device in a storage device, where the neuron images include a plurality of neurons stored within. Then, whether there is a connection between each of neurons and the other neurons in the three dimensional or higher dimensional neuron image database is determined by the processing device. Subsequently a shortest pathway table of all of the connected neurons is calculated via an All-pairs Shortest Paths algorithm and is temporarily or permanently stored in the storage device. Therefore, as long as any two connected neurons are selected from the three dimensional or higher dimensional neuron image database, the shortest pathway between the two neurons can be obtained in real-time by looking up the aforementioned shortest pathway table in the storage device.

In some embodiments of the present invention, the method described above may be performed by a local processing device. Alternatively, in other some embodiments of the present invention, the method described above may be performed by a processing device in a remote server Which is connected to network.

In the aforementioned embodiments, the three dimensional or higher dimensional neural space database may be constructed from a plurality of unit voxels in the multi-dimensional neuron image space.

Furthermore, the determining step mentioned above includes establishing a connection matrix (CM) between the plurality of neurons from the three dimensional or higher dimensional neural space database, where CM(i, j)=1 denotes that there is a connection between a neuron nᵢ and a neuron nⱼ; CM(i, j)=0 denotes that there is no connection between the neuron nᵢ and the neuron nⱼ.

A shortest pathway matrix (represented by SP) and a predecessor matrix (represented by Pred) are generated in the All-pairs Shortest Paths algorithm. When SP(i, j)=∞, it denotes that there is no connection between a neuron nᵢ and a neuron nⱼ; when Pred(i, j)=nil (i.e. empty set), it denotes that a shortest pathway between a node i and a node j is Edge(i, j); when Pred(i, j)=k, it denotes that the shortest pathway from the node i to the node j passes a node k, where the node k is the predecessor of the node j on the shortest pathway from the node i to the node j. The predecessor matrixes may be stored in the form of tables and the shortest pathway between any two nodes is established by looking up the predecessor table. The shortest pathway within all nodes needs not to be calculated repeatedly.

Based on the above description, neurology researchers may establish the database by employing the neural images interested via the aforementioned method and can then find out the shortest pathways between every two neurons in the database easily and rapidly through the method described in this invention, so as to facilitate the studies on neural functions and disease with persuasive anatomical descriptions.

### BRIEF DESCRIPTION OF THE DRAWINGS

FIG. 1 illustrates a flow chart of the method for finding the shortest pathways between neurons in neural network in accordance with the present invention;

FIG. 2 illustrates an architecture diagram of the system applied to perform the method for finding the shortest pathways between neurons in neural network in accordance with one embodiment of the present invention;

FIG. 3 illustrates an architecture diagram of the system applied to perform the method for finding the shortest pathways between neurons in neural network in accordance with another embodiment of the present invention;

FIG. 4 illustrates a diagram of a unit voxel utilized to construct the three dimensional neural space database in accordance with the present invention;

FIG. 5A illustrates an architecture diagram of the manipulation interface applied in the present invention; and

FIG. 5B illustrates a diagram of the manipulation interface applied in the present invention in accordance with one embodiment.

### DETAILED DESCRIPTION OF THE PREFERRED EMBODIMENT

The present invention will now be described with the embodiments and aspects taken together with the accompanying drawings and these descriptions interpret structure and procedures of the present invention only for illustrating but not for limiting the Claims of the present invention. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

The embodiments and details which will be described in detail below include descriptions in connection with the drawings. The description in connection with the drawings may be described in some embodiments or in all embodiments below as other potential embodiments or implementations of the invention concepts presented herein. The embodiments of the present invention are described in great detail below. Please refer to the drawings.

The present invention relates to a method for finding the shortest pathways between neurons in neural network through neuron image data. In other words, the method for finding the shortest pathways between neurons in neural network is utilized to receive information of two neurons (for example names or IDs), calculate the connecting neurons between the two neurons and output complete pathway information.

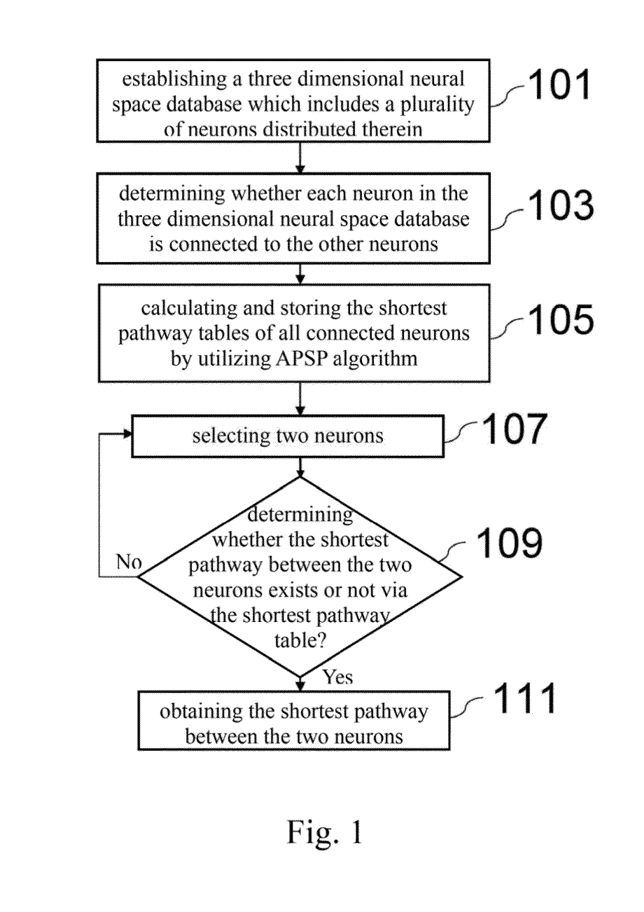

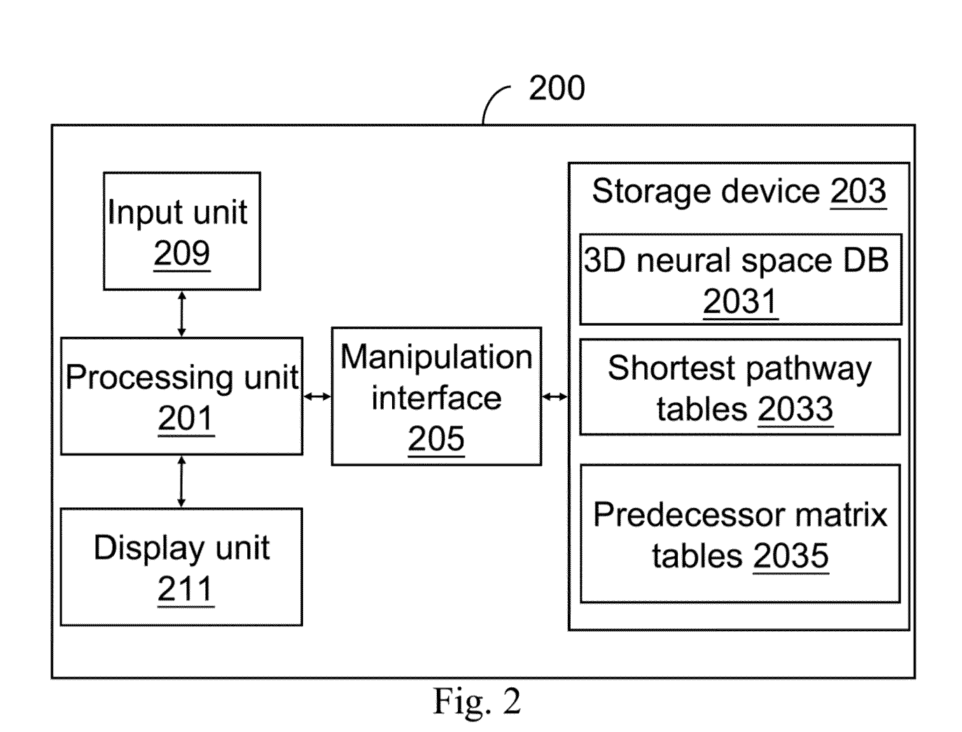

Please refer to FIG. 1, which is a flow chart of the method for finding the shortest pathways between neurons in neural network, taken together with FIGS. 2 to 5.

Firstly, the first step of the method for finding the shortest pathways between neurons through neuron image data disclosed by the present invention is to establish a three dimensional neural space database (also referred to as three dimensional neuron image database) which includes a plurality of neurons distributed within three dimensional neural space database (step 101).

It should be noted that although this embodiment is described with the three dimensional neural space database as an example, the present invention is not limited to the three dimensional neural space database but may be applied to higher dimensional neural space databases.

Please refer to FIG. 2 first, which is an architecture diagram of the system applied to perform the method for finding the shortest pathways between neurons in neural network in accordance with one embodiment. In this example, the system 200 may be performed by a single processing device. The system (processing device) 200 may include a processing unit 201 to process the operation of the system (processing device) 200; and a storage device 203 to store data. Furthermore, the system 200 may also include a manipulation interface 205 connected to the processing unit 201 and the storage device 203 respectively. The storage device 203 includes storage spaces, and three dimensional neural space databases 2031, shortest pathway table(s) 2033 and predecessor matrix table(s) 2035 (which will be described in detail below) may be stored in the storage spaces. In the present invention, the manipulation interface 205 and the storage spaces of the storage device 203 are connected to each other, such that the user can establish and manipulate the three dimensional neural space database 2031 through the manipulation interface 205. Moreover, in this exemplary example, the system (processing device) 200 further includes an input unit 209 and a display unit 211, both of which are electrically coupled to the processing unit 201, such that the display unit 211 may display the pictures of the manipulation interface 205 in order for the user to view them, and the user may manipulate the manipulation interface 205 through the input unit 209.

In some embodiments of this exemplary example, the system (processing device) 200 may be composed of a computer system, where the processing unit 201 may be performed by a central processing unit (CPU), and the storage device 203 may include any kinds of readable recording medium, such as magnetic storage device, optical storage device or volatile storage device, and shall not be limited thereto. Further, the input unit 209 may be performed by any kinds of components or devices for computer input, for instance mouse, keyboard, touch panel, etc, and shall not be limited thereto. The display unit 211 may also be performed by any kinds of components or device for display, for example liquid crystal display (LCD) device, etc.

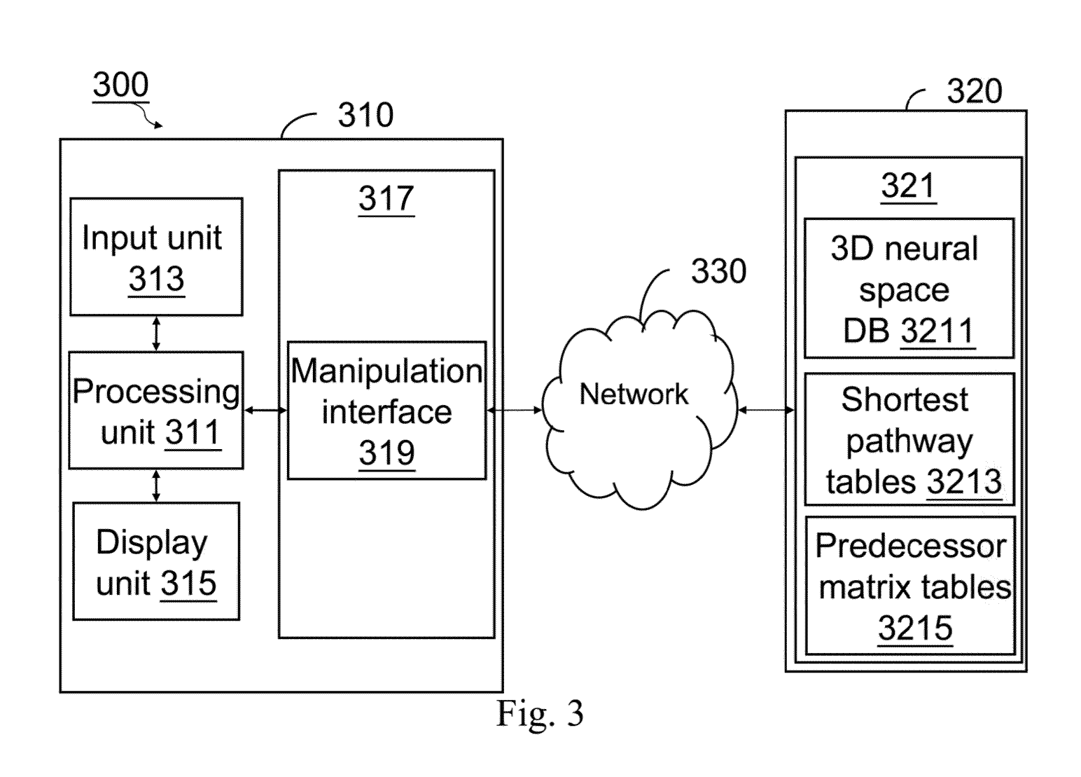

Furthermore, please refer to FIG. 3, which is an architecture diagram of the system applied to perform the method for finding the shortest pathways between neurons in neural network in accordance with another embodiment. In this exemplary example, the system 300 may be composed of a processing device 310, a server 320 and a network 330. The processing device 310 generally includes a processing unit 311, an input unit 313, a display unit 315 and a storage unit 317. The storage unit 317 is electrically coupled to the processing unit 311, and a manipulation interface 319 is disposed therein. The input unit 313 and the display unit 315 are electrically coupled to the processing unit 311 respectively. It should be noted that the processing device 310 may further include other auxiliary units or components which are not so relevant to the present invention. However, it should be easily appreciated by the person having ordinary skill in the art that the processing device 310 may or may not include these auxiliary units or components, which are therefore omitted herein.

The server 320 generally includes a storage device 321, and a three dimensional (3D) neural space database (DB) 3211 is established in the storage spaces of the storage device 321. Similarly, the storage device 321 also stores shortest pathway tables 3213 and predecessor matrix tables 3215 (which will be described in detail below).

It should be noted that the server 320 may also include other auxiliary units, or necessary components which are not so relevant to the present invention. However, it should be easily appreciated by the person having ordinary skill in the art that the server 320 may or may not include these components, which are therefore omitted herein.

In this embodiment, the processing device 310 and the server 320 may connect to each other through a network. More specifically, the user can employ the manipulation interface 319 in the processing device 310 to connect with the three dimensional neural space database 3211 established in the storage device 321 in the remote server 320 through the network 330, and can establish and manipulate the three dimensional neural space database 3211 via the manipulation interface 319.

Similarly, in some embodiments of this exemplary example, the processing device 310, the server 320 and the network 330 may be performed and operated by any kinds of existing processing devices, servers and networks, which are therefore omitted therein.

In the present invention, the establishment of the three dimensional neural space database (which may also be referred to as three dimensional neuron image database) 2031, 3211 is derived from the concept of spatial database management system (SDBMS). SDBMS is applied to geographic information system (GIS) initially, and is also utilized in different fields later. For instance, molecular biologists can employ SDBMS to search and compare the structures of different genes, and astronomers can also utilize SDBMS to search and analyze the constellations. Therefore, as long as all of the objects to be searched are located in the same coordinate space, SDBMS can be employed to sort and analyze them to help the researchers.

The method for establishing the three dimensional neural space database utilized in the present invention may refer to the disclosure in a Taiwan Patent Application Number 098115595, entitled “A METHOD FOR SEARCHING AND CONSTRUCTING 3D IMAGE DATABASE”.

The method for establishing the three dimensional neural space database (which may also be referred to as three dimensional neuron image database) 2031, 3211 may be generally divided into the preprocessing of three dimensional image and management of the neuron image. Each set of Drosophila brain neural images may be obtained, and each set of the obtained Drosophila brain neural images was warped and registered by employing the preprocessing steps and may be represented with tracing lines. The ends of the tracing lines may be the terminals of the neurons. These terminals represent the portions of the neurons which are responsible for information exchange. Thus, if the distance between the terminals of two neurons is less than a certain range, we assume that these two neurons are connected to each other, and the information exchanges happen between these two neurons.

Each neural image datum and each tracing line may be warped into a normalized Drosophila brain coordinate system, and the space occupied by neural images and each terminal have corresponding spatial coordinates. Thus, a Spatial Database Management System (SDBMS) may be employed to store and manage the information included in the Drosophila brain images, and the relationship querying function may be provided through the Drosophila neural image information stored in SDBMS.

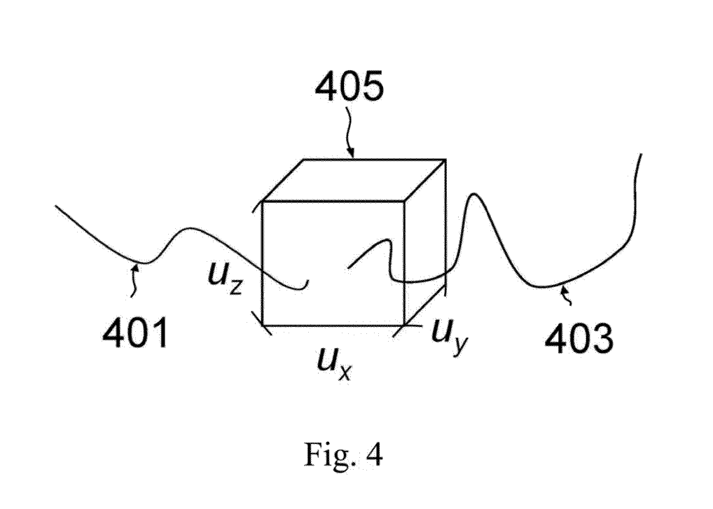

In the present invention, the establishment of the three dimensional neural space database 2031, 3211 is described as follows: a unit voxel u (please refer to FIG. 4) is defined in the space where all of the registered neural images are located (it is assumed that the dimensions of neuron image space in X, Y and Z directions are set to be Sx, Sy and Sz respectively), and the size of the unit voxel is set to be ux×uy×uz. The defined unit voxel u may be of different size, and the larger the unit voxel u is, the higher the fault tolerance will be. Dx, Dy and Dx denotes the number of the unit voxels which each dimension in this space can accommodate, i.e. Dx=Sx/ux, Dy=Sy/uy and Dz=Sz/uz. In other words, this neural space may include a number of Dx×Dy×Dz unit voxels.

In one embodiment of the present invention, the unit voxel may be 2×2×2 pixels, and the standard brain space may be 1944×1222×740 pixels, but is not limited thereto.

After the three dimensional neural space database 2031, 3211 which includes a plurality of neurons distributed therein is established, it is determined whether each neuron in the three dimensional neural space database 2031, 3211 is connected to the other neurons (step 103).

In the present invention, when the database 2031, 3211 is established, the connecting relationship between two neurons may be found by querying the database to know that if the terminals of these two neurons are located within the same unit voxel. There may be errors in the processing procedure of the neural images. Therefore, a threshold may be defined. In this embodiment, the size of a unit voxel is set as the threshold. Thus, if any one of terminals of one neuron and any one of terminals or part of the trace of another neuron are located within the same unit voxel, it is taken that a connection exists between the two neurons. That is, information is transmitted between the two neurons at such point. With reference to FIG. 4, the cube 405 represents a unit voxel, and the unit voxel 405 in which a terminal of a first neuron 401 is located has a second neuron 403 passing through. Thus, it may be considered that there is a connection between the first neuron 401 and the second neuron 403.

Therefore, when the database 2031, 3211 is established, the database 2031, 3211 may be employed to find the neuron(s) connected with all other possible neurons. For instance, in order to find neuron(s) connected with a neuron nᵢ, the first step is to find out all of the unit voxels through which the neuron nᵢ passes, and then all of the neurons which pass through these unit voxels can be found from the database 2031, 3211.

In other word, for each unit voxel u in a number of Dx×Dy×Dz unit voxels, the neurons passing through the unit voxel u are found, and this related information is stored in the three dimensional neural space database (also referred to as three dimensional neuron image database) 2031, 3211 established in step 101. The database 2031, 3211 mainly includes the location of the unit voxel (ux, uy, uz), and the content is the names of all of the neurons passing through this unit voxel (which may be represented by ID (identification number)).

Connection matrix (also referred to as adjacency matrix) between neurons may be built up via the aforementioned concepts. It is assumed first herein that there are m records stored in the database 2031, 3211, i.e. there are m neurons. Thus, a m×m matrix, which is represented by CM, may be established. When CM(i, j)=1, it denotes that there is a connection between the neuron nᵢ and the neuron nⱼ. Contrarily, when CM(i, j)=0, it denotes that there is no connection between the neuron nᵢ and the neuron nⱼ. In such way, the values in the whole CM matrix are filled, and this CM matrix is the connection matrix showing the connecting relationship between neurons.

In the present invention, when the connection matrix between every two neurons is built up, the connection matrixes among all neurons may be converted into a undirected graph to represent them. Under this structure, each neuron is equivalent to a node. A connection between two neurons is equivalent to that there is a connecting edge between two nodes. Thus, if there is a connection between the neuron nᵢ and the neuron nⱼ, i.e. CM(i, j)=1, it denotes that there is an edge with a weight of 1 between the node i and the node j. The algorithm of graph analysis in graph theory may then be applied to the neuron connection structure. In one exemplary example of the present invention, the neural images to be used are the neural images of Drosophila brain, which has about thirteen thousand neurons for now. Therefore, it is equivalent to that the shortest pathways have to be found from a graph with about thirteen thousand nodes. It's better to find out the shortest pathway in real-time. Traditionally, the shortest pathways are usually calculated by utilizing Dijkstra's algorithm, in which a certain node is utilized as a starting node, and the shortest pathways from the starting node to all of the other nodes are then calculated. If the traditional method is applied to the prose system, the shortest connecting pathways between one node among ten thousand nodes and the other nodes among the ten thousand nodes have to be searched respectively. It is very difficult for the processing devices 200, 310 to find the shortest pathways in real-time.

In the present invention, all pairs shortest paths (APSP) may be calculated by employing Floyd-Washall Algorithm, which is also referred to as APSP algorithm. This calculating method can calculate the shortest pathways among all neurons which are connected to one another. Although there are thirteen thousand neurons in this embodiment and the computation is very time-consuming, i.e. the dimension of the connection matrix is around 13000×13000, the present invention calculates the shortest pathways among all connected neurons only one once and establishes shortest pathway matrix tables to store the shortest pathways (step 105).

When the APSP algorithm is applied to the computation of the connection matrixes of the present invention, two matrixes will be generated, where one is the shortest path (SP) matrix, i.e. SP(i, j) is the distance of the short pathway from the node i to the node j, and the other is predecessor matrix (Fred). Thus, if SP(i, j)=∞, it denotes that there is no pathway to connect the node i and the node j. There are two situations for Pred(i, j) as follow: when Pred(i, j)=nil (i.e. an empty set), it represents that the shortest pathway between the node i and the node j is Edge(i, j); when Pred(i, j)=k, it represents that the shortest pathway from the node i to the node j may pass the node k, where the node k is the predecessor of the node j on the shortest pathway from the node i to the node j.

Therefore, in order to find the shortest pathway (Path(i, j)) between the neuron nᵢ and the neuron nⱼ, the SP matrix needs to be checked first. if SP(i, j) is not ∞, it denotes that the shortest pathway exists. Then, the shortest pathway may be found from the Fred matrix. Moreover, if Pred(i, j)=k, the shortest pathway between the node i and the node j is Path(i, k) plus Path(k, j), such that the shortest pathway between the neuron nᵢ and the neuron nⱼ can be found.

The predecessor matrixes and the shortest pathway matrixes may be stored in the form of tables as the predecessor matrix table 2035, 3215 and the shortest pathway matrix table 2033, 3213 respectively. When the shortest pathway between any two neurons is to be searched, the pathway may be found directly by look-up-table (LUT) and the APSP algorithm needs not to be performed every time.

Thus, the shortest pathway tables (predecessor tables) may be formed through the aforementioned method and may be then stored in the storage device 203, 321.

After the shortest pathway tables are completed, as long as two neurons may be selected from the three dimensional neural space database 2031, 3211 (step 107), it can be determined whether the shortest pathway exists between the two neurons or not by looking up the aforementioned shortest pathway tables (step 109).

When it is determined that the shortest pathway exists, the shortest pathway between the two neurons may be obtained (step 111). Otherwise, return to step 107 and reselect two neurons.

As described above, when the shortest pathway between any two neurons in the three dimensional neural space database (also referred to as three dimensional neuron image database) 2031, 3211 is to be searched, the step 109 may be utilized first to determine whether the shortest pathway exists or not. If yes, the shortest pathway between the two neurons may be found rapidly through the table formed from the predecessor matrixes.

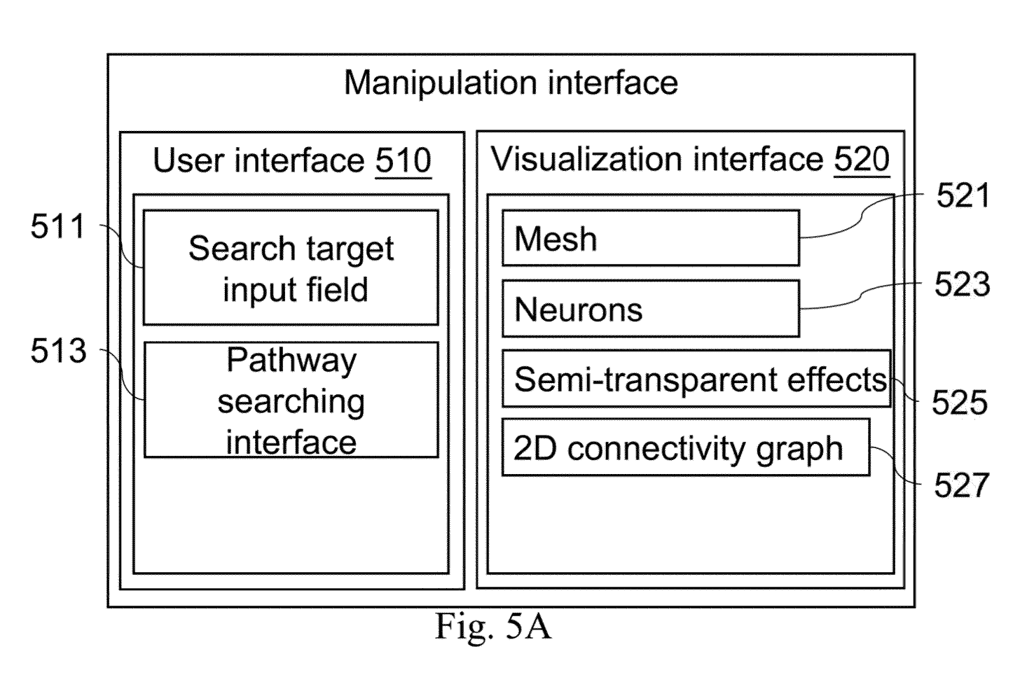

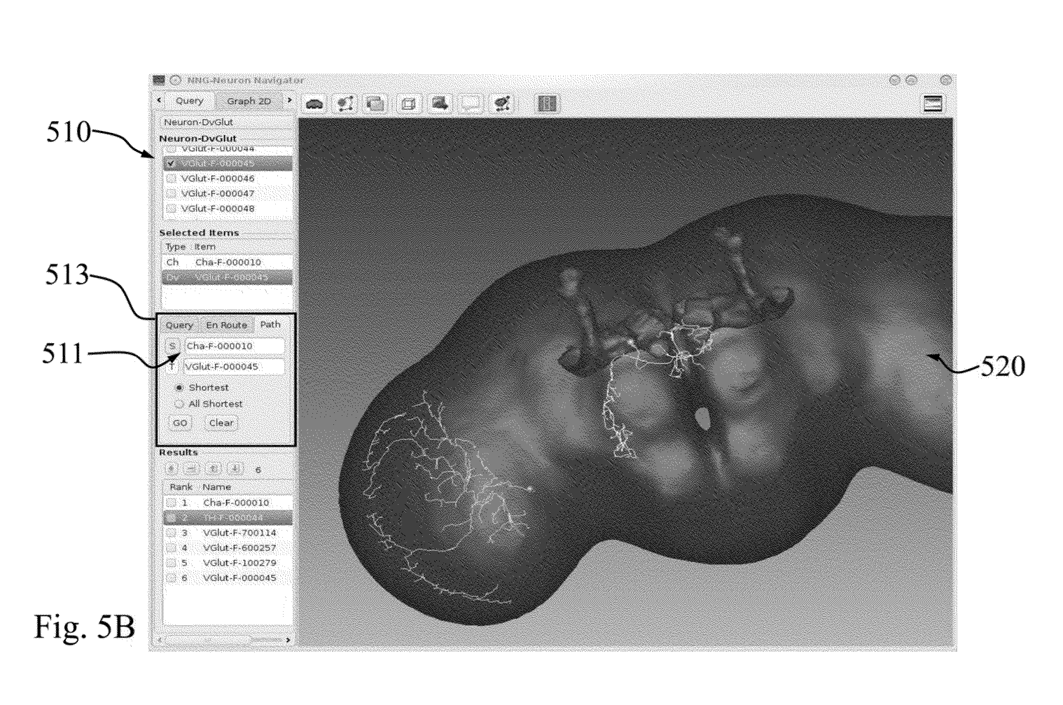

In this embodiment, if the whole matrix cannot be loaded once due to the limitation of the system, the table may be split into several sub-pages and only the necessary sub-pages are loaded because the number of the nodes is about thirteen thousand and a 13000×13000 matrix includes a large amount of information. The loading and paging of sub-pages may be performed via the least recent used (LRU) method. It should be noted that each step of the method for finding the shortest pathway between neurons disclosed by the present invention is performed by the system (processing device) 200 or the system 300. The manipulation interface 205, 319 may be performed as the structure disclosed in FIG. 5A. With reference to FIG. 5B, which is a diagram of the manipulation interface applied in the present invention in accordance with one embodiment, the manipulation interface 205, 319 may include two portions, which are the user interface 510 and the visualization interface 520 respectively.

The user interface 510 may include the following several functions but be not limited thereto: a pathway searching interface (Path Query) 513 and a search target input field (Query) 511, which enable the user to perform the manipulating action or the selecting action via the input unit 209, 313. Furthermore, the visualization interface 520 may include the following several functions but be not limited thereto: mesh 521, neuron 523, semi-transparent effects 525 and two dimensional connectivity graphs 527, which enable the user to recognize the neural images in a graphical way. Therefore, the user may manipulate the three dimensional neural space database 2031, 3211 via the manipulation interface 205, 319 mentioned above, and after the user inputs the shortest pathway search commands, the computation may be performed by the processing unit 201, 311.

Based on the above description, neurology researchers may establish the database by employing the neural images interested via the aforementioned method and can then find out the shortest pathways between every two neurons in the database easily and rapidly through the method described in the present invention, so as to facilitate the studies on neural functions and disease with persuasive anatomical descriptions.

It should be appreciated that the embodiments and the attached drawings are described and illustrated for purposes of illustration only, not for limiting, and that numerous alterations and modifications may be practiced by those skilled in the art without departing from the spirit and scope of the present invention. It is intended that all such modifications and alterations are included insofar as they come within the scope of the present invention as claimed or the equivalents thereof.

What is claimed is:

1. A method for finding shortest pathways between neurons in a neural network, comprising the following steps:
establishing a three dimensional or higher dimensional neural space database by a processing device in a storage device of said processing device, wherein said three dimensional or higher dimensional neural space database comprises a plurality of neurons distributed therein;
determining whether there is a connection between each of said plurality of neurons in said three dimensional or higher dimensional neural space database and the others of said plurality of neurons in said three dimensional or higher dimensional neural space database by said processing device; and
calculating a shortest pathway table of all of a plurality of connected neurons via an algorithm and temporarily or permanently storing said shortest pathway table in said storage device.

2. The method of claim 1, further comprising the following steps:
selecting two neurons from said plurality of neurons and looking up said shortest pathway table by said processing device to obtain a shortest pathway between said two neurons.

3. The method of claim 1, wherein said three dimensional or higher dimensional neural space database is constructed from a plurality of unit voxels.

4. The method of claim 1, wherein the determining step comprises establishing a connection matrix (CM) between said plurality of neurons from said three dimensional or higher dimensional neural space database.

5. The method of claim 4, wherein CM(i, j)=1 denotes that there is a connection between a neuron nᵢ and a neuron nⱼ; CM(i, j)=0 denotes that there is no connection between said neuron nᵢ and said neuron nⱼ.

6. The method of claim 1, wherein said algorithm is All-pairs Shortest Paths algorithm.

7. The method of claim 6, wherein a shortest pathway matrix (SP) and a predecessor matrix (Pred) are generated in said All-pairs Shortest Paths algorithm.

8. The method of claim 7, wherein SP(i, j)=∞ denotes that there is no connection between a neuron nᵢ and a neuron nⱼ; Pred(i, j)=nil denotes that a shortest pathway between a node i and a node j is Edge(i, j); Pred(i, j)=k denotes that said shortest pathway from said node i to said node j passes a node k, wherein said node k is a predecessor of said node j on said shortest pathway from said node i to said node j.

9. The method of claim 1, wherein said neural space database is a 3D neuron image database.

10. A method for finding shortest pathways between neurons in a neural network, comprising the following steps:
connecting a processing device and a server via a network, wherein said server includes a storage device;
establishing a three dimensional or higher dimensional neural space database in said storage device and a manipulation interface to manipulate said three dimensional or higher dimensional neural space database by said processing device, wherein said three dimensional or higher dimensional neural space database comprises a plurality of neurons distributed therein;
determining whether there is a connection between each of said plurality of neurons in said three dimensional or higher dimensional neural space database and the others of said plurality of neurons in said three dimensional or higher dimensional neural space database by said processing device; and
calculating a shortest pathway table of all of a plurality of connected neurons via an algorithm and temporarily or permanently storing said shortest pathway table in said storage device.

11. The method of claim 10 further comprising the following steps:
selecting two neurons from said plurality of neurons via said manipulation interface and looking up said shortest pathway table by said processing device to obtain a shortest pathway between said two neurons.

12. The method of claim 10, wherein said three dimensional or higher dimensional neural space database is constructed from a plurality of unit voxels,

13. The method of claim 10, wherein the determining step comprises establishing a connection matrix (CM) between said plurality of neurons from said three dimensional or higher dimensional neural space database.

14. The method of claim 13, wherein CM(i, j)=1 denotes that there is a connection between a neuron nᵢ and a neuron nⱼ; CM(i, j)=0 denotes that there is no connection between said neuron nᵢ and said neuron nⱼ.

15. The method of claim 10, wherein said algorithm is All-pairs Shortest Paths algorithm.

16. The method of claim 15, wherein a shortest pathway matrix (SP) and a predecessor matrix (Pred) are generated in said All-pairs Shortest Paths algorithm.

17. The method of claim 16, wherein SP(i, j)=∞ denotes that there is no connection between a neuron nᵢ and a neuron nⱼ; Pred(i, j)=nil denotes that a shortest pathway between a node i and a node j is Edge(i, j); Pred(i, j)=k denotes that said shortest pathway from said node i to said node j passes a node k, wherein said node k is a predecessor of said node j on said shortest pathway from said node i to said node j.

18. The method of claim 10, wherein said neural space database is a 3D neuron image database.
